(19) United States
(12) Patent Application Publication
(10) Pub. No.: US 2011/0031425 A1
(43) Pub. Date: Feb. 10, 2011

(54) MOTOR OPERATED BUTTERFLY VALVE

(75) Inventor: Jeff Tyler, Newark, NY (US)

Correspondence Address: BROWN & MICHAELS, PC;400 M & T BANK BUILDING, 118 NORTH TIOGA ST, ITHACA, NY, 14850, US

(73) Assignee: G. W. LISK COMPANY, INC., Clifton Springs, NY (US)

(21) Appl. No.: 12/936,455

(22) PCT Filed: Apr. 7, 2009
(86) PCT No.: PCT/US09/39776

§ 371 Date: Oct. 5, 2010

Related U.S. Application Data
(60) Provisional application No. 61/042,824, filed on Apr. 7, 2008.

(51) Int. Cl. F16K 31/02

(52) U.S. Cl. 251/129.11

(57) ABSTRACT

A system for operating a valve including a motor shaft driven by a motor, a cam, a non-contact sensor, and a butterfly valve plate mounted on a butterfly valve shaft. The cam has an exterior profile and is mounted to the motor shaft. The non-contact sensor is proximate to the cam's exterior profile. The butterfly shaft is coupled to the motor shaft. A selected position of the butterfly valve plate may be set by activating the motor to a position determined by sensing the cam profile by the non-contact sensor.

### REFERENCE TO RELATED APPLICATIONS

This application claims one or more inventions which were disclosed in Provisional Application No. 61/042,824 filed Apr. 7, 2008, entitled “MOTOR OPERATED BUTTERFLY VALVE”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of valves. More particularly, the invention pertains to a motor operated butterfly valve.

2. Description of Related Art

Prior art electric exhaust gas recirculation (EGR), turbo charger waste gate, and cooler bypass, and exhaust gas restricting valve systems suffer from multiple problems. Common problems associated with the electric operated valve systems are soot migrating into the motor, rotor slippage and the encoder/sensors of the system failing due to the high ambient and radiant temperatures in the system. Other problems such as internal leakage can also occur with improper sealing of the butterfly valve plate.

FIGS. 16 and 17 show schematics of prior art butterfly valves sealing with the valve housing.

FIG. 16 shows a prior art butterfly valve plate 120 l mounted on a shaft 124 sealing on a first flat side 120a of the butterfly valve plate 120 with a first flat seat face 123b and sealing on an opposing second flat side 120b, opposite the first flat side 120a of the butterfly valve plate 120 with a second flat seat face 123c formed opposite the first flat seat face 123b. The first and second seat faces 123b, 123c are formed integrally with the valve housing 123. There are numerous problems with this butterfly valve design. One of the problems associated with this type of butterfly valve is that exhaust coking of soot can easily build up between the butterfly valve plate 120 and the flat seal faces of the seats 123b, 123c, causing internal leakage problems. It is also difficult to mate both seal faces flat sides 120a, 120b of the with the butterfly valve plate 120 at the same time.

FIG. 17 shows another prior art butterfly valve. The butterfly valve plate 220 seals against the inner diameter 223a of the valve housing 223. From a manufacturing standpoint, it is difficult to manufacture and have the prior art butterfly valve plate 220 seal uniformly with the inner diameter 223a of the valve housing 223. If the butterfly valve plate 220 does not seal uniformly with the inner diameter 223a of the valve housing 223, high internal leakage results. Additionally, soot coking builds up in the inner diameter 223a of the valve housing 223, where the butterfly valve plate 220 has to seal.

### SUMMARY OF THE INVENTION

An electric driven valve system that uses a non-contact cam profile sensor to control a butterfly valve in the pneumatic management systems of a combustion engine. The sensor detects the motion of the cam, independent of actual motor rotation, providing closed loop control. Since the sensor is detecting the motion of the cam independent of the actual motor rotor rotation, if the motor rotor does slip, it will not affect control of the butterfly valve in the pneumatic management system of the combustion engine.

Butterfly valve plate designs are also disclosed.

### BRIEF DESCRIPTION OF THE DRAWING

FIG. 1 shows a side view of a motor operated valve of a first embodiment of the present invention.

FIG. 2 shows a sectional view of the motor operated valve of the first embodiment of the present invention.

FIG. 3 shows a side view of a motor operated valve of a second embodiment of the present invention.

FIG. 4 shows a sectional view of the motor operated valve of the second embodiment of the present invention.

FIG. 5 shows a side view of the butterfly valve.

FIG. 6 shows an example of a cam profile.

FIG. 7 shows another example of a cam profile.

FIG. 8 shows a view of the motor operated valve of the third embodiment of the present invention.

FIG. 9 shows a cross-section of the motor operated valve of the third embodiment of the present invention.

FIG. 10 shows an enlarged view of the bevel gears of the third embodiment of the present invention.

FIG. 11 shows a cross-section of a motor operated valve of a fourth embodiment of the present invention.

FIG. 12 shows another cross-section of the motor operated valve of the fourth embodiment of the present invention.

FIG. 13a shows another side view of the butterfly valve plate of the present invention. FIG. 13b shows an exploded view of the butterfly valve plate shown in FIG. 13a.

FIG. 14 shows another butterfly valve plate of the present invention.

FIG. 15 shows another example of a butterfly valve plate of the present invention.

FIG. 16 shows an example of a prior art butterfly valve plate.

FIG. 17 shows another example of a prior art butterfly valve plate.

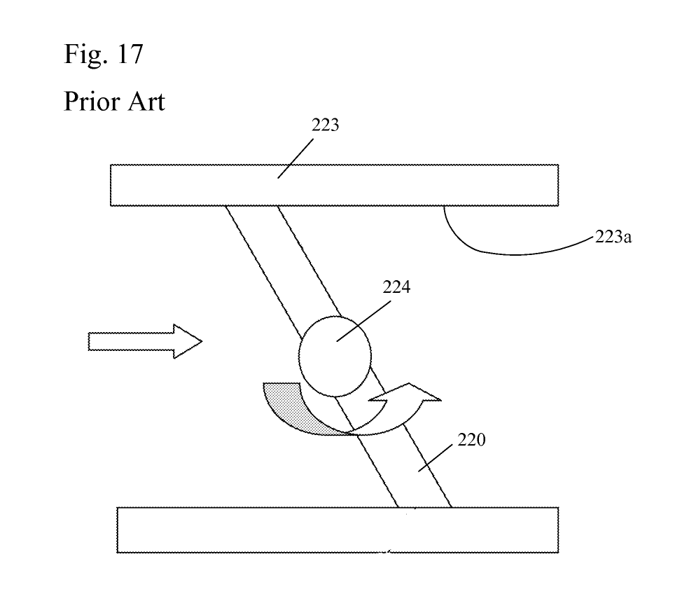

### DETAILED DESCRIPTION OF THE INVENTION

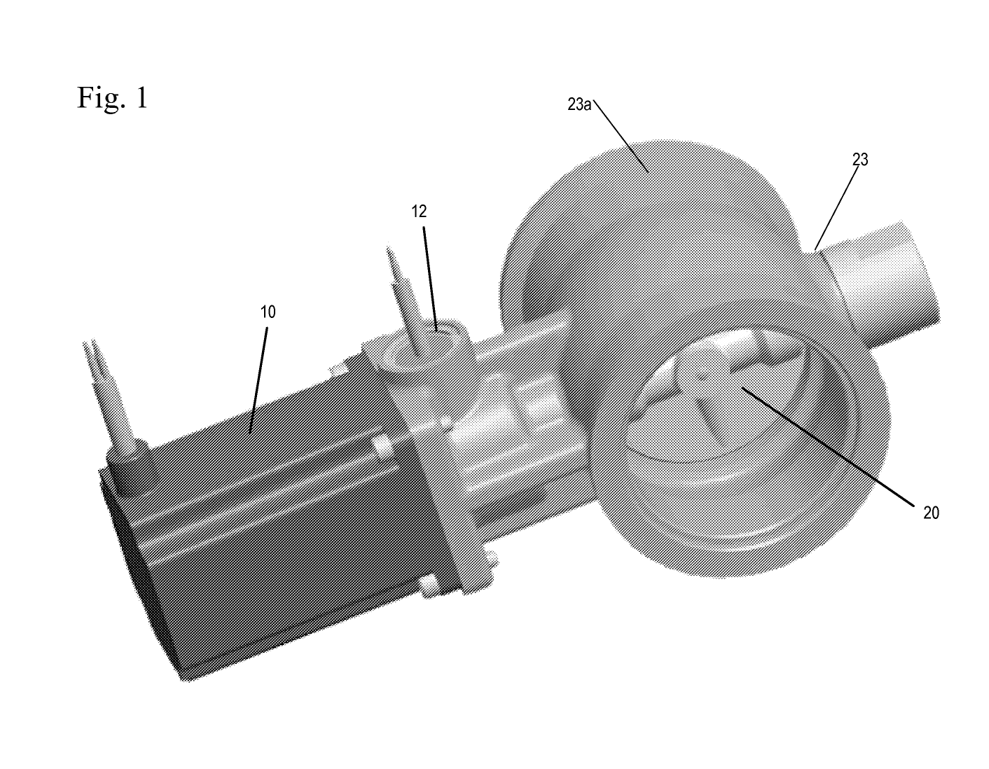

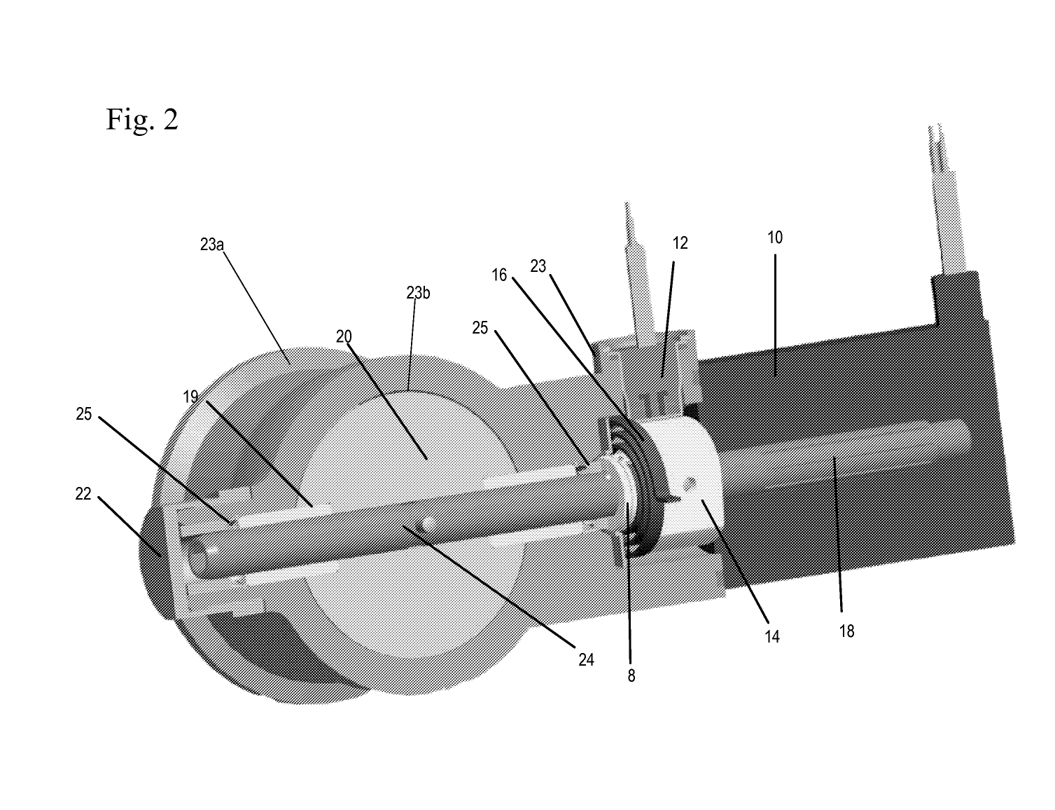

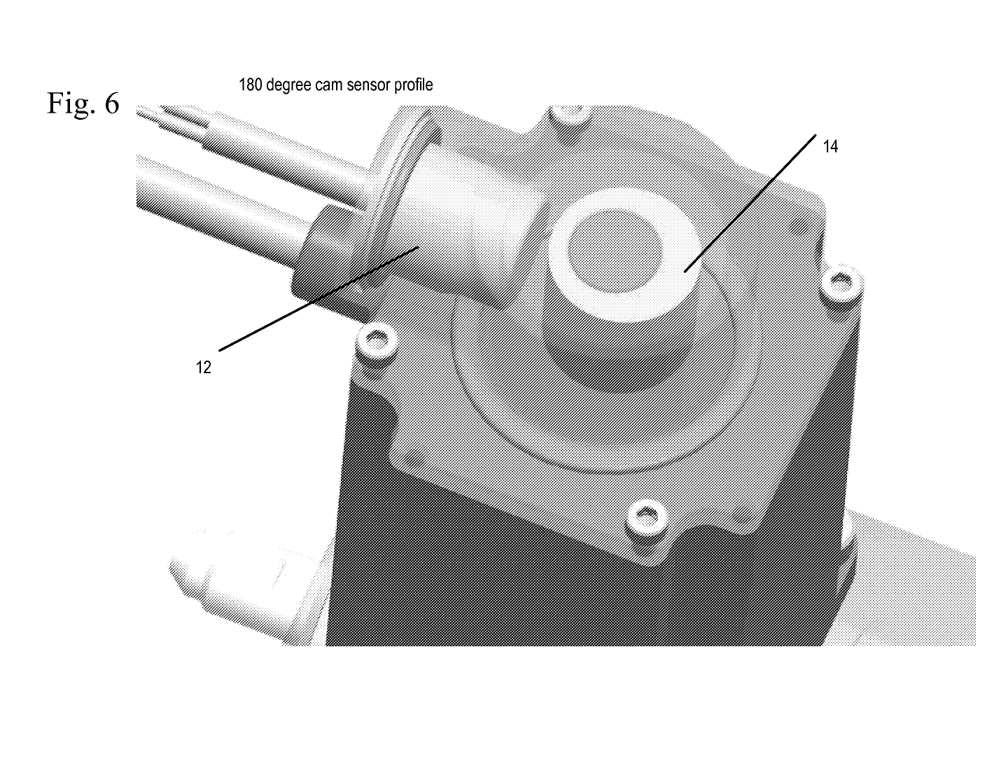

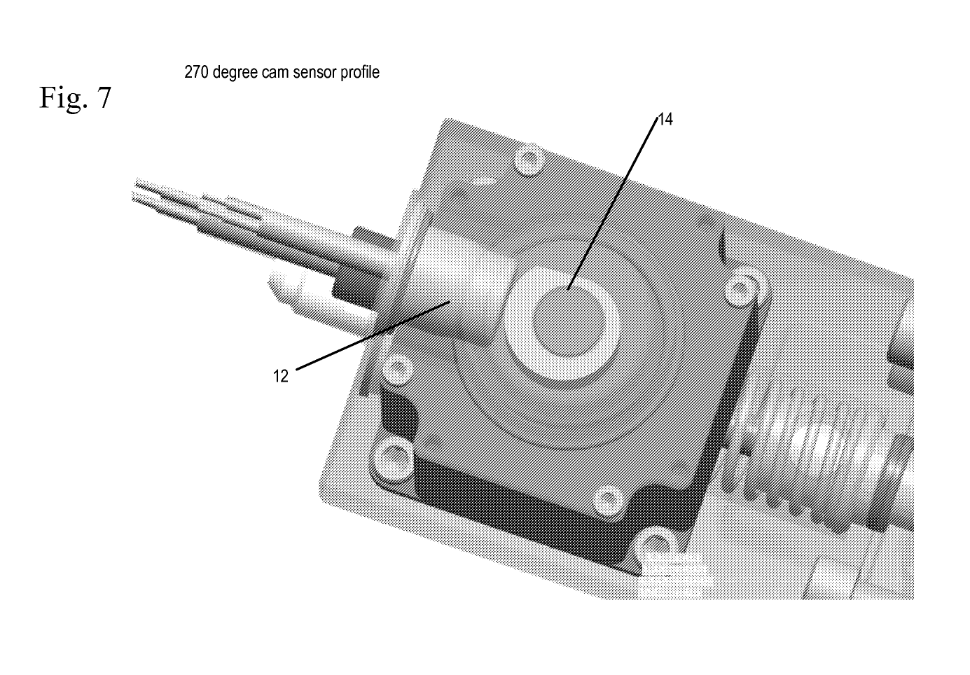

FIGS. 1-2 show a motor operated butterfly valve of the first embodiment. A motor 10 is connected to valve housing 23. The motor 10 drives a motor shaft 18 with a cam 14 on an end. The cam 14 is present within the valve housing 23 at a first end adjacent to the motor 10. A non-contact sensor 12 within the valve housing 23 is aligned and positioned with the cam 14 to sense the profile of the cam 14 as it rotates. The cam profile is not limited to profile shown in any of the figures. If desired, only a portion of the cam profile may be sensed, as shown in FIGS. 6-7, where 180 degrees and 270 degrees of the cam are being sensed. The information from the non-contact sensor 12 is sent and monitored by the ECU (not shown). Based on the information from the non-contact sensor 12 and other engine parameters the ECU adjusts the motor 10, in turn adjusting the position of the butterfly valve 20.

A first end 24a of a butterfly shaft 24 is received by a flange 8 on the cam 14 within the valve housing 23. The butterfly shaft 24 extends the length of the housing 23 to a second end 24b. The second end 24b of the butterfly shaft 24 fits into a bearing 19. The cap 22 is used to keep out environmental contamination and contains any soot passed the butterfly shaft 24 to bearing 19 fit from exiting the assembly. The butterfly valve plate 20 is received within a cylindrical portion 23a of the valve housing 23 and is connected to the butterfly shaft 24 between the first end 24a and the second end 24b of the butterfly shaft 24 and between bearings 19. The cylindrical portion 23a of the valve housing 23 has an integrally formed angled seat 23c within the inner diameter 23b.

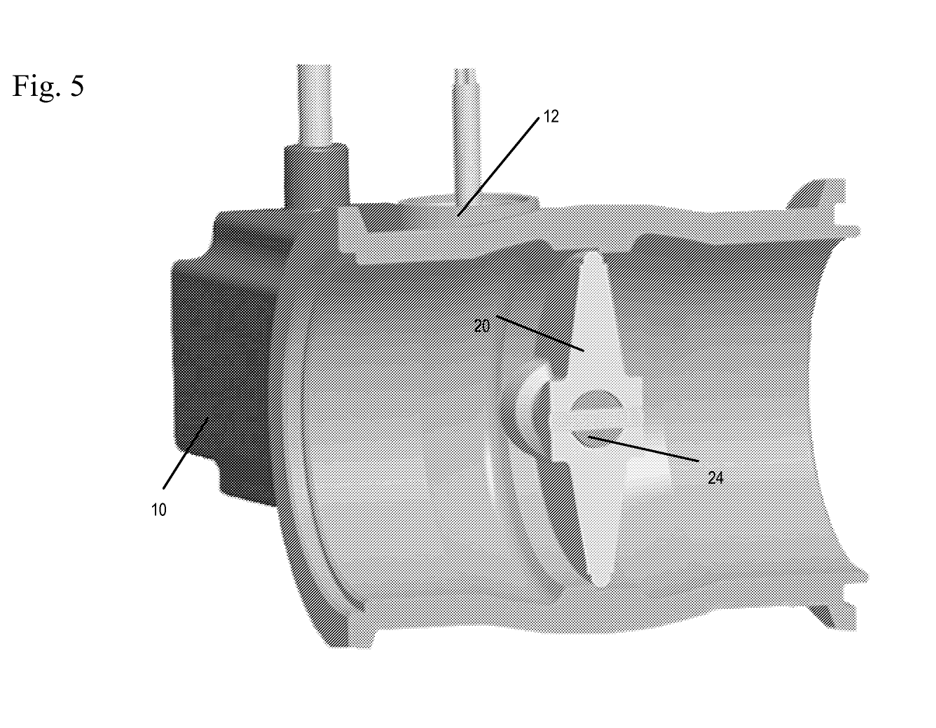

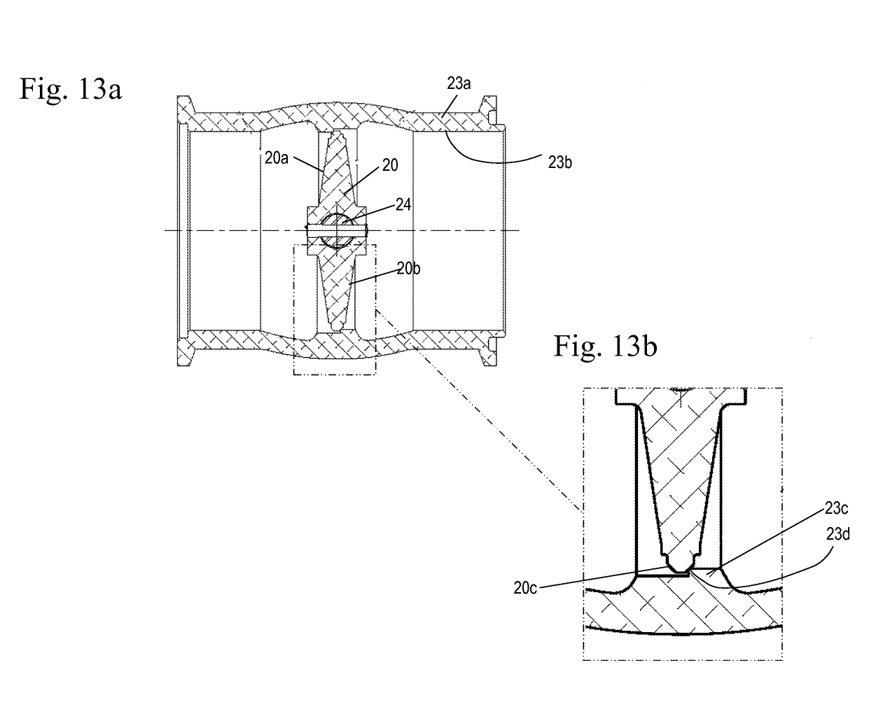

As shown in FIGS. 5, 13a, and 13b the butterfly valve plate 20 has a first side 20a and a second side 20b, the first side 20a being opposite from the second side 20b. The outer circumference of the butterfly valve plate 20 has angled end faces 20c that make line contact with an edge or corner 23d of the integrally formed angled seat 23c in the inner diameter 23b of the cylindrical portion 23a of the valve housing 23. When the butterfly shaft 24 is rotated, moving the butterfly valve plate 20 to a sealing position, the angled end face 20c formed on the outer circumference of the butterfly valve plate 20 on a first side 20a and a second side 20b seals at line contact with the corner or edge 23d of the integrally formed seat 23c in the inner diameter 23b of the cylindrical portion 23a of the valve housing 23. By having the seal formed between the edge 23d of integrally formed seat 23c and the angled face 20c on the outer circumference of the butterfly valve plate 20, soot does not coke up and internal leakage is low. Because of the edge sealing and the ability to brinell (coin) the mating surfaces of the angular face and the edge so that they conform exactly to one another, the seating stresses are high as compared with other designs. This enhances the low internal leakage sealing ability.

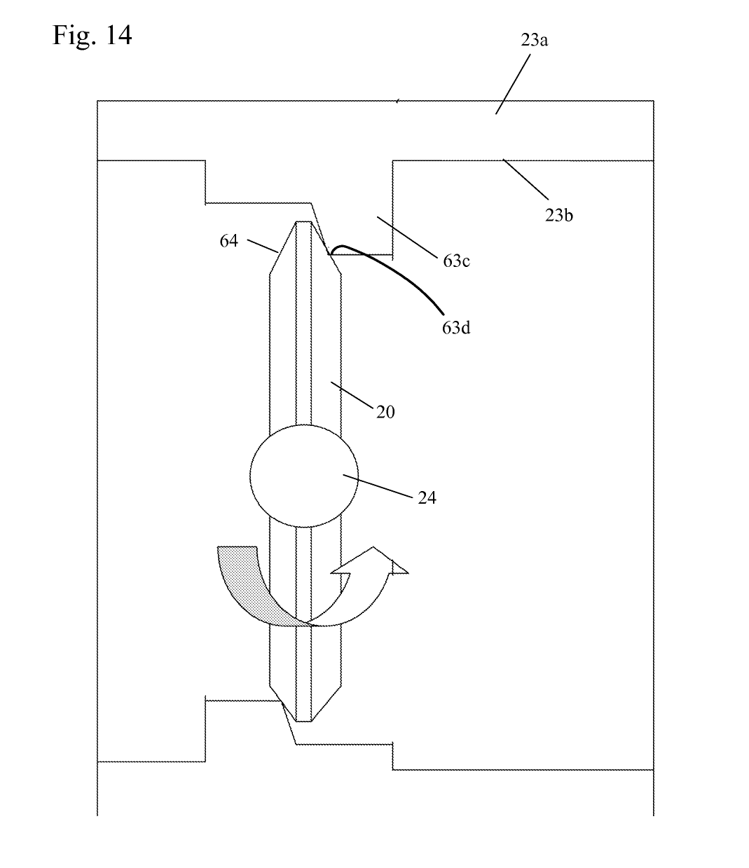

FIG. 14 shows an example of different geometry formed on the outer circumference of the butterfly valve plate 20. Instead of only a small portion of the outer circumference of the butterfly valve plate 20 having an angled edge as in FIGS. 13a and 13b, a significantly larger portion of the outer circumference of the butterfly valve plate has an angled edge. In other words, the angled edge extends from the tip of the outer circumference of the butterfly valve plate to the sides of the butterfly valve plate 20a, 20b. As in FIGS. 5, 13a, and 13b, when the butterfly shaft 24 is rotated, moving the butterfly valve plate 20 to a sealing position, the large angled end face 20c formed on the outer circumference of the butterfly valve plate 20 on a first side 20a and a second side 20b seals at line contact with the corner or edge 23d of the integrally formed seat 23c in the inner diameter 23b of the cylindrical portion 23a of the valve housing 23. By having the seal formed between the edge 23d of integrally formed seat 23c and the large angled face 20c on the outer circumference of the butterfly valve plate 20, soot does not coke up and internal leakage is low. Because of the edge sealing and the ability to brinell (coin) the mating surfaces of the angular face and the edge so that they conform exactly to one another, the seating stresses are high as compared with other designs. This enhances the low internal leakage sealing ability.

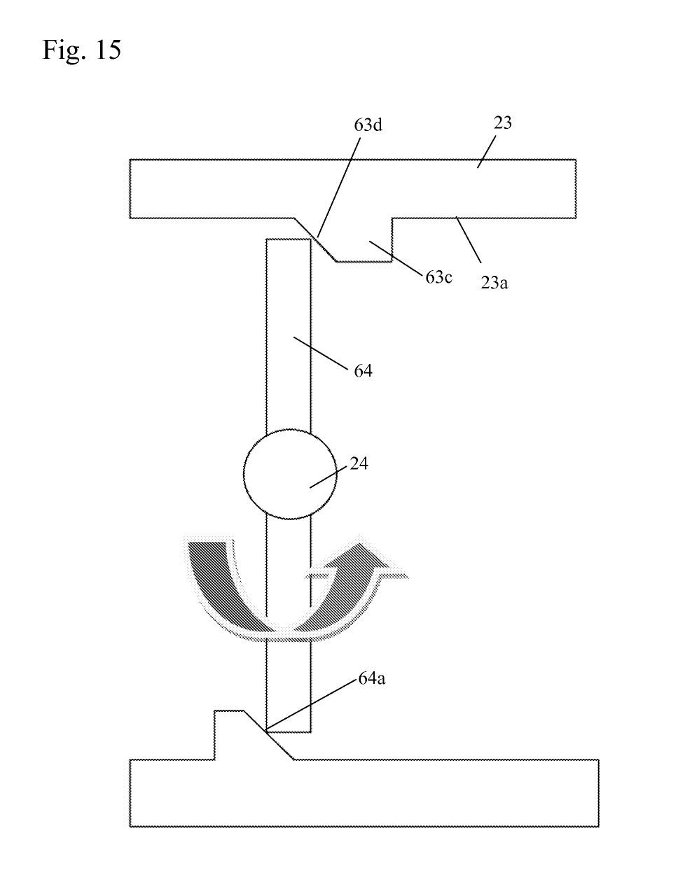

FIG. 15 shows a butterfly valve plate 64 of an alternate embodiment in which the integrally formed seat 63c in the inner diameter 23b of the cylindrical portion 23a of the valve housing 23 has an angled seat 63d and the butterfly valve plate 64 has squared outer edges 64a. When the butterfly shaft 24 is rotated, moving the butterfly valve plate 64 to a sealing position as shown in the figure, the edges 64a on the outer circumference of the butterfly valve plate 64 seals at line contact with the angled edge 63d of the integrally formed seat 63c on the inner diameter 23b of the cylindrical portion 23a of the valve housing 23.

The angular face 20c or edge 64a on the outer circumference of the butterfly valve plate 20, 64 as shown in FIGS. 5, 13a, 13b, 14, and 15 when mating with the edge 23d or angular face 63d on the inner diameter 23b of the cylindrical portion 23a of the valve housing 23 also prevents the butterfly valve plate 20, 64 from wedging, ensuring that the butterfly valve plate 20, 64 hits the valve housing 23 at two positive stops. The angular face 20c or edge 64a on the outer circumference of the butterfly valve plate 20, 64 also reduces the required torque required by the motor 10 since the butterfly valve plate 20, 64 doesn't wedge with the cylindrical portion 23a of the valve housing 23. The edge 64a or angular face 20c on the outer circumference of the butterfly valve plate 64, 20 and the edge 23d or angular face 63d of the seat prevents soot build up since soot and debris cannot accumulate on the edges of the edge seal design. The design of the butterfly valve plate 20, 64 and the design of the seat provides low internal leakage when the butterfly valve plate 20, 64 is closed, giving superior low leakage performance, improving the dynamic flow range of the valve. Because of the edge sealing and the ability to brinell (coin) the mating surfaces of the angular face and the edge so that they conform exactly to one another, the seating stresses are high as compared with other designs. This enhances the low internal leakage sealing ability.

In any of the above embodiments, the edges 23d of the integrally formed seat and the angular face 20c of the butterfly valve plate 20 or the angular face 63d of the integrally formed seat and the edge 64a of the butterfly valve plate 64, the tolerance due to manufacturing yielding the seat and the butterfly valve plate may be coined out such that the entire outer circumference of the butterfly valve plate hits the seat at the same time. In a preferred embodiment, the materials of the integrally formed seat and the material of the butterfly valve plate have nearly the same coefficient of linear thermal expansion, such that no change is leakage performance is present over a temperature range.

The mating of the edge seals on the outer circumference of the butterfly valve plate with the seat in the cylindrical housing, regardless of whether the angular edge is on the butterfly valve plate or the seat or the edge or corner is on the butterfly valve plate or the seat, results in an angular face to angular edge mating. Planar surface to surface contact between the butterfly valve plate and seat of the cylindrical portion of the valve housing does not occur.

### EXAMPLE 1

Bench tests of a 2.570 in diameter butterfly plate were run at 10 through 80 PSIG (pounds per square inch gauge) with edge sealing as disclosed above as resulted in the following standard cubic feet per minute of leakage.

| Pounds per | | | | | | | | |
|---|---|---|---|---|---|---|---|---|
| square | | | | | | | | |
| inch gauge | 10 | 20 | 30 | 40 | 50 | 60 | 70 | 80 |
| (PSIG) | PSIG | PSIG | PSIG | PSIG | PSIG | PSIG | PSIG | PSIG |
| Present | 6.4 | 9.4 | 13.9 | 21.0 | 28 | 36.9 | 45.6 | 56.5 |
| Invention | | | | | | | | |
| Butterfly Valve | scfm | scfm | scfm | scfm | scfm | scfm | scfm | scfm |
| Plate with edge | | | | | | | | |
| sealing in | | | | | | | | |
| standard | | | | | | | | |
| cubic feet per | | | | | | | | |
| minute (scfm) | | | | | | | | |

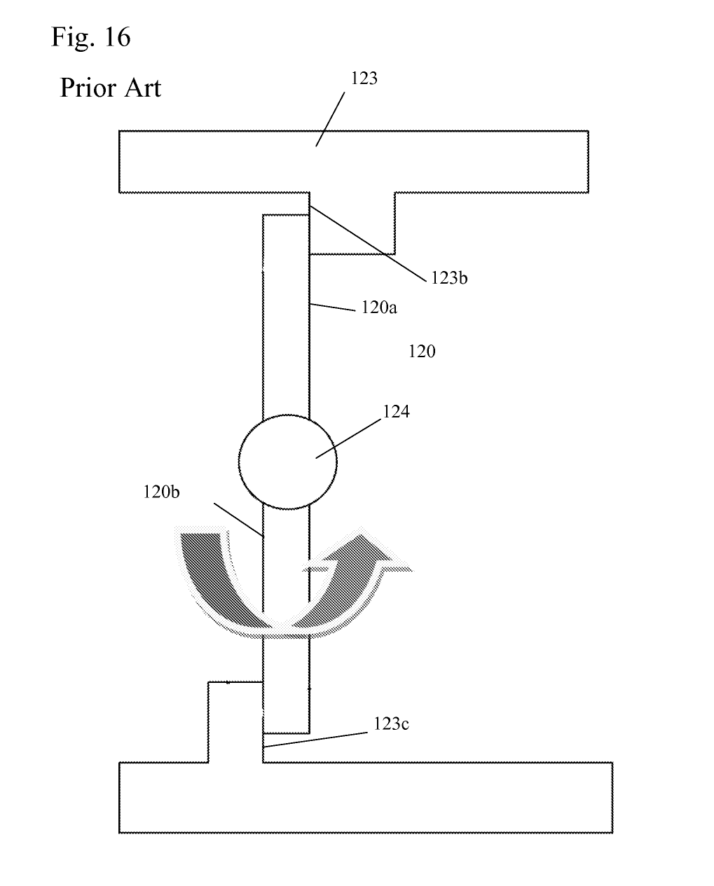

At 40 PSIG, the prior art sealing technique shown in FIG. 16, the amount of leakage was 100 standard cubic feet per minute. The present invention provides five times better leakage rate at 40 PSIG.

The flange 8 of the cam 14 also receives a spiral spring 16. The spring 16 biases the butterfly valve plate 20 to a closed position. Seals 25 are present between the butterfly shaft 24 and the valve housing 23 at the first end 24a of the butterfly shaft 24 and at the second end 24b of the butterfly shaft 24 preventing soot and debris from entering into the motor 10 and other parts of the assembly. The butterfly shaft 24 and the motor shaft 18 may be formed of one common shaft.

The motor 10 may be a stepper motor or any other type of electric motor.

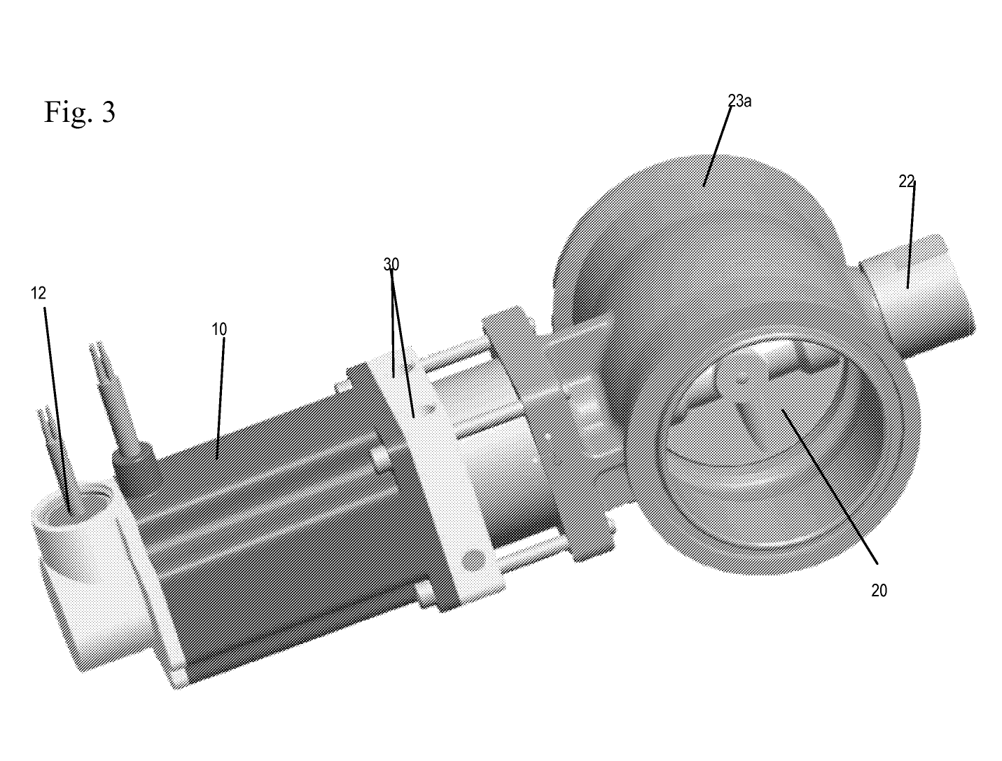

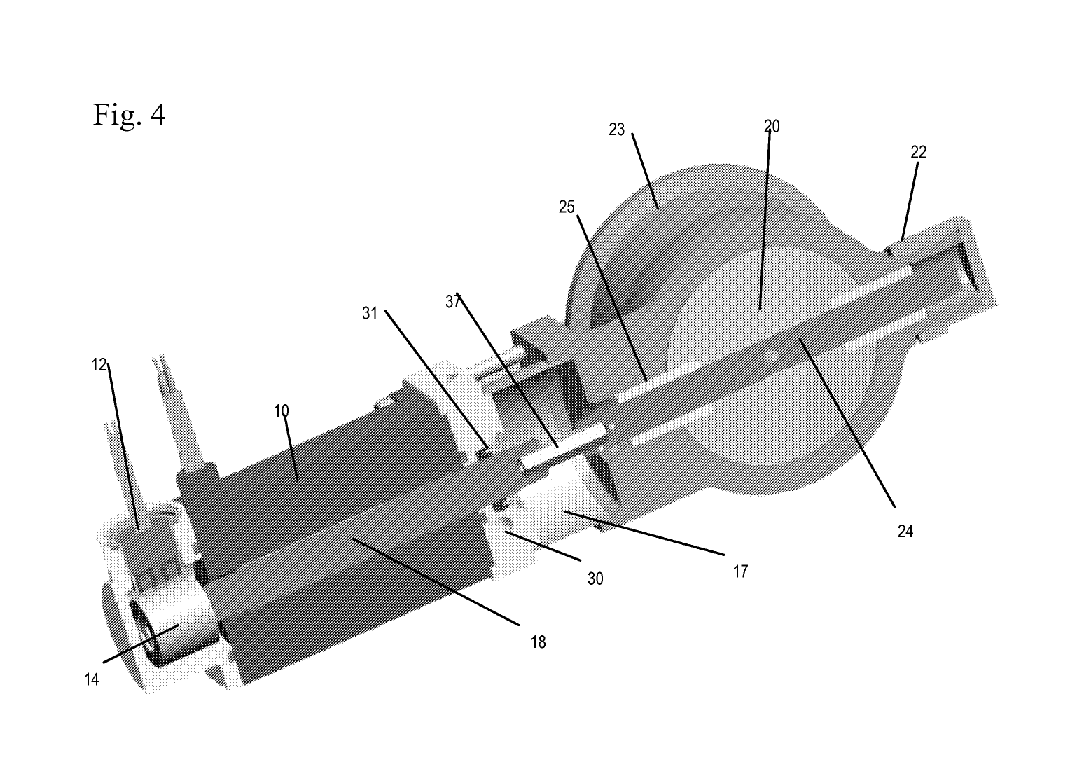

FIGS. 3-4 show a motor driven butterfly valve of a second embodiment. A motor 10 is connected to a valve housing 23 through a cooler 30. The motor 10 drives a motor shaft 18 having a first end 18a with cam 14. Seal 31 on the motor shaft 18 prevents exhaust soot and debris from entering into the motor 10. A non-contact sensor 12 is aligned and positioned with cam 14 to sense the profile of the cam 14 as it rotates. The cam profile is not limited to profile shown in any of the figures. If desired, only a portion of the cam profile may be sensed, as shown in FIGS. 6-7 where 180 degrees and 270 degrees of the cam are being sensed. The information from the non-contact sensor 12 is sent to and monitored by the ECU (not shown). Based on the information from the non-contact sensor 12 and other engine parameters the ECU adjusts the motor 10, in turn adjusting the position of the butterfly valve 20.

The second end 18b of the motor shaft 18 is connected to the first end 24a of a butterfly shaft 24 through coupling 37, for example a hex pin drive. The coupling 37 also serves as a thermal break between the butterfly shaft 24 and motor shaft 18. Adjacent to the motor 10 is a cooler 30 for cooling the seals 31 and the motor 10. The butterfly shaft 24 extends the length of the housing to a second end. The second end 24b of the butterfly shaft 24 fits into a bearing 19. The cap 22 is used to keep out environmental contamination and contains any soot passed the butterfly shaft 24 to bearing 19 fit from exiting the assembly. The butterfly valve plate 20 is received within a cylindrical portion 23a of the valve housing 23 and is connected to the butterfly shaft 20 between the first end 24a and the second end 24b of the butterfly shaft 24.

Bearing 19 are present between the butterfly shaft 24 and the valve housing 23 at the first end 24a of the butterfly shaft 24 and at the second end 24b of the butterfly shaft 24.

As shown in FIGS. 5, 13a, and 13b the butterfly valve plate 20 has a first side 20a and a second side 20b, the first side 20a being opposite from the second side 20b. The outer circumference of the butterfly valve plate 20 has angled end faces 20c that make line contact with an edge or corner 23d of the integrally formed angled seat 23c in the inner diameter 23b of the cylindrical portion 23a of the valve housing 23. When the butterfly shaft 24 is rotated, moving the butterfly valve plate 20 to a sealing position, the angled end face 20c formed on the outer circumference of the butterfly valve plate 20 on a first side 20a and a second side 20b seals at line contact with the corner or edge 23d of the integrally formed seat 23c in the inner diameter 23b of the cylindrical portion 23a of the valve housing 23. By having the seal formed between the edge 23d of integrally formed seat 23c and the angled face 20c on the outer circumference of the butterfly valve plate 20, soot does not coke up and internal leakage is low. Because of the edge sealing and the ability to brinell (coin) the mating surfaces of the angular face and the edge so that they conform exactly to one another, the seating stresses are high as compared with other designs. This enhances the low internal leakage sealing ability.

The angular face 20c or edge 64a on the outer circumference of the butterfly valve plate 20, 64 as shown in FIGS. 5, 13a, 13b, 14, and 15 when mating with the edge 23d or angular face 63d on the inner diameter 23b of the cylindrical portion 23a of the valve housing 23 also prevents the butterfly valve plate 20, 64 from wedging, ensuring that the butterfly valve plate 20, 64 hits the valve housing 23 at two positive stops. The angular face 20c or edge 64a on the outer circumference of the butterfly valve plate 20, 64 also reduces the required torque required by the motor 10 since the butterfly valve plate 20, 64 doesn't wedge with the cylindrical portion 23a of the valve housing 23. The edge 64a or angular face 20c on the outer circumference of the butterfly valve plate 64, 20 and the edge 23d or angular face 63d of the seat prevents soot build up since soot and debris cannot accumulate on the edges of the edge seal design. The design of the butterfly valve plate 20, 64 and the design of the seat provides low internal leakage when the butterfly valve plate 20, 64 is closed, giving superior low leakage performance, improving the dynamic flow range of the valve.

In any of the above embodiments, the edges 23d of the integrally formed seat and the angular face 20c of the butterfly valve plate 20 or the angular face 63d of the integrally formed seat and the edge 64a of the butterfly valve plate 64, the tolerance due to manufacturing yielding the seat and the butterfly valve plate may be coined out such that the entire outer circumference of the butterfly valve plate hits the seat at the same time. In a preferred embodiment, the materials of the integrally formed seat and the material of the butterfly valve plate have nearly the same coefficient of linear thermal expansion, such that no change is leakage performance is present over a temperature range.

Alternatively, as shown in FIG. 15, the butterfly valve plate may have an squared outer edge and the and the integrally formed seat in the inner diameter 23b of the cylindrical portion 23a of the valve housing 23 has an angled seat.

The mating of the edge seals on the outer circumference of the butterfly valve plate with the seat in the cylindrical housing, regardless of whether the angular edge is on the butterfly valve plate or the seat or the edge or corner is on the butterfly valve plate or the seat, results in an angular face to angular edge mating. Planar surface to surface contact between the butterfly valve plate and seat of the cylindrical portion of the valve housing does not occur. Because of the edge sealing and the ability to brinell (coin) the mating surfaces of the angular face and the edge so that they conform exactly to one another, the seating stresses are high as compared with other designs. This enhances the low internal leakage sealing ability.

Tube 17 between the motor 10 and the housing 23 which includes the coupling 37 provides a thermal break between the motor 10 and the housing 23, allows proper alignment between the motor 10 and housing 23, and an enclosure to prevent soot from escaping the assembly.

The motor 10 may be a stepper motor or any other type of electric motor.

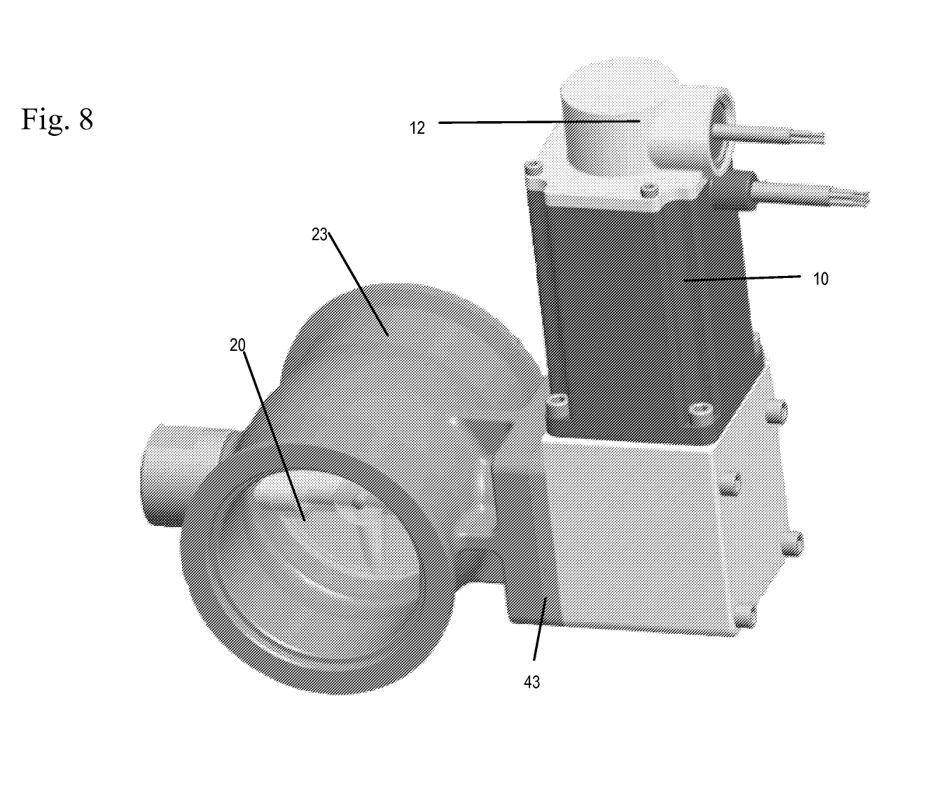

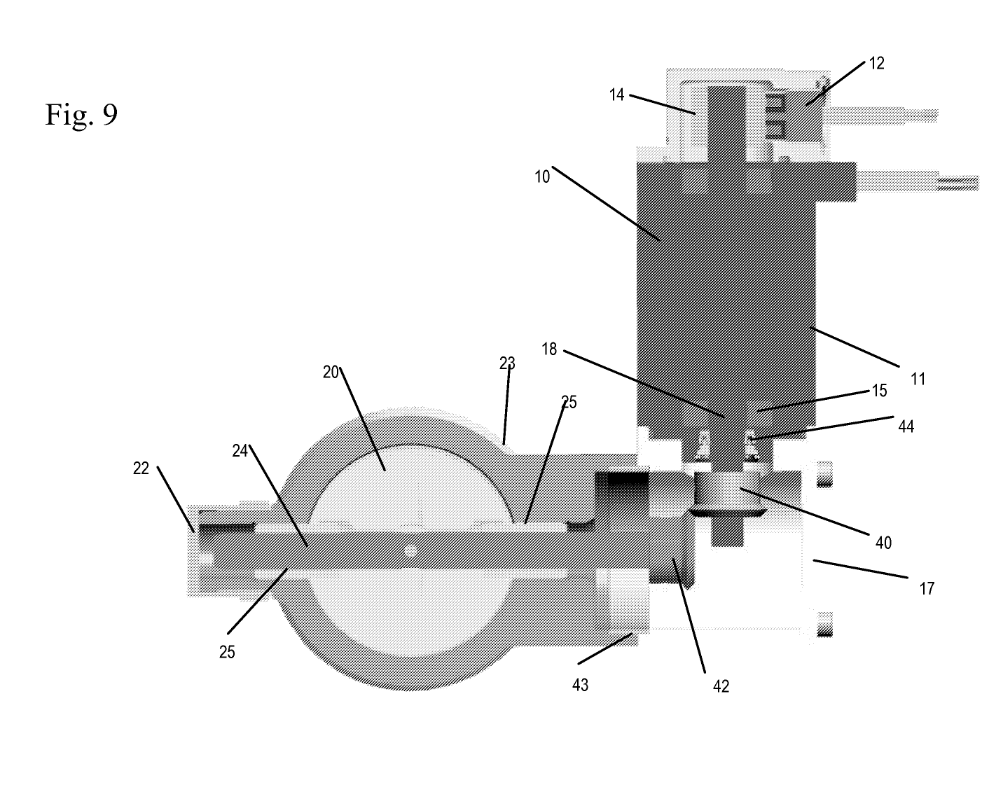

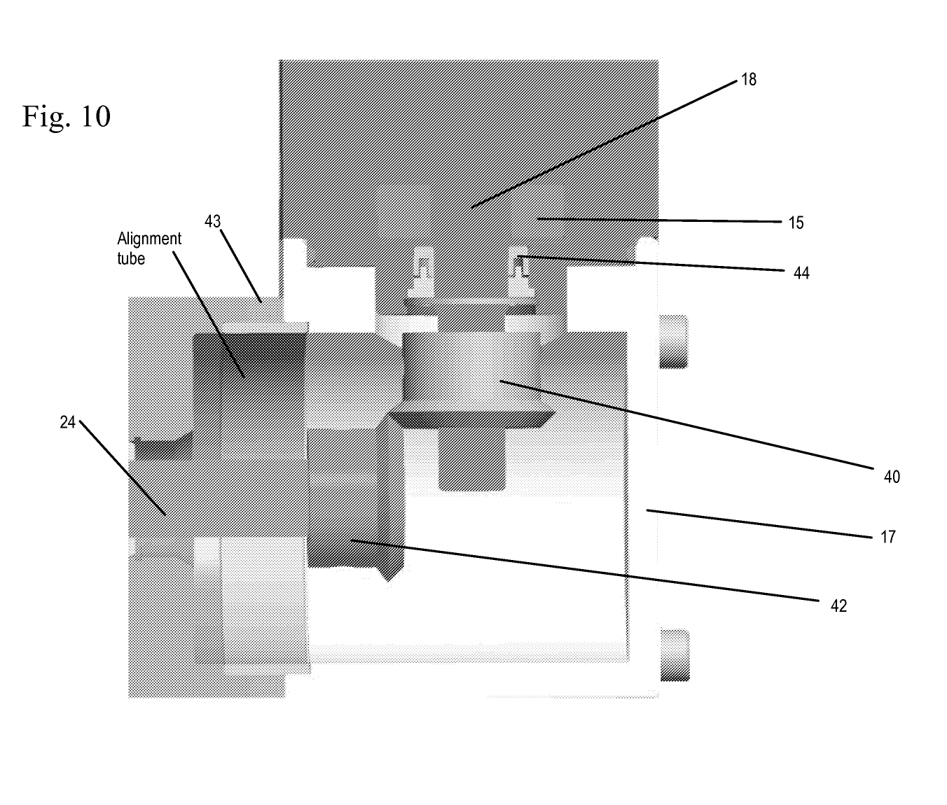

FIGS. 8-10 show a motor operated butterfly valve of a third embodiment. A motor 10 is connected to valve housing 23. The motor 10 drives a motor shaft 18 having a first end 18a with cam 14. A non-contact sensor 12 is aligned and positioned with cam 14 to sense the profile of the cam 14 as it rotates. The cam profile is not limited to profile shown in any of the figures. If desired, only a portion of the cam profile may be sensed, as shown in FIGS. 6-7 where 180 degrees and 270 degrees of the cam are being sensed. The information from the non-contact sensor 12 is sent to the ECU (not shown). Based on the information from the non-contact sensor 12 and other engine parameters the ECU adjusts the motor 10, in turn adjusting the position of the butterfly valve 20.

The second end 18b of the motor shaft 18 has a first bevel gear 40 mounted thereon. The first bevel gear 40 mates with a second bevel gear 42 mounted on a first end 24a of a butterfly shaft 24. The butterfly shaft 24 extends the length of the housing 23 to a second end. The second end 24b of the butterfly shaft 24 fits into a bearing 19. The cap 22 is used to keep out environmental contamination and contains any soot passed the butterfly shaft 24 to bearing 19 fit from exiting the assembly. The butterfly valve plate 20 is received within the cylindrical portion 23a of the valve housing 23 and is connected to the butterfly shaft 24 between the first end 24a and the second end 24b of the butterfly shaft 24 and between bearings 19. A thermal break 43 is present between the motor housing 11 and the valve housing 23. Tube 17 between the motor housing 11 and the valve housing 23 which includes bevel gear set 40, 42 provides an additional thermal break between the motor housing 11 and the valve housing 23, allows proper alignment between the motor housing 11 and valve housing 23, and an enclosure to prevent soot from escaping the assembly.

Seals 44 are present between the motor shaft and the motor and may be cooled by water or oil by including passages in the housing 23.

As shown in FIGS. 5, 13a, and 13b the butterfly valve plate 20 has a first side 20a and a second side 20b, the first side 20a being opposite from the second side 20b. The outer circumference of the butterfly valve plate 20 has angled end faces 20c that make line contact with an edge or corner 23d of the integrally formed angled seat 23c in the inner diameter 23b of the cylindrical portion 23a of the valve housing 23. When the butterfly shaft 24 is rotated, moving the butterfly valve plate 20 to a sealing position, the angled end face 20c formed on the outer circumference of the butterfly valve plate 20 on a first side 20a and a second side 20b seals at line contact with the corner or edge 23d of the integrally formed seat 23c in the inner diameter 23b of the cylindrical portion 23a of the valve housing 23. By having the seal formed between the edge 23d of integrally formed seat 23c and the angled face 20c on the outer circumference of the butterfly valve plate 20, soot does not coke up and internal leakage is low. Because of the edge sealing and the ability to brinell (coin) the mating surfaces of the angular face and the edge so that they conform exactly to one another, the seating stresses are high as compared with other designs. This enhances the low internal leakage sealing ability.

The angular face 20c or edge 64a on the outer circumference of the butterfly valve plate 20, 64 as shown in FIGS. 5, 13a, 13b, 14, and 15 when mating with the edge 23d or angular face 63d on the inner diameter 23b of the cylindrical portion 23a of the valve housing 23 also prevents the butterfly valve plate 20, 64 from wedging, ensuring that the butterfly valve plate 20, 64 hits the valve housing 23 at two positive stops. The angular face 20c or edge 64a on the outer circumference of the butterfly valve plate 20, 64 also reduces the required torque required by the motor 10 since the butterfly valve plate 20, 64 doesn't wedge with the cylindrical portion 23a of the valve housing 23. The edge 64a or angular face 20c on the outer circumference of the butterfly valve plate 64, 20 and the edge 23d or angular face 63d of the seat prevents soot build up since soot and debris cannot accumulate on the edges of the edge seal design. The design of the butterfly valve plate 20, 64 and the design of the seat provides low internal leakage when the butterfly valve plate 20, 64 is closed, giving superior low leakage performance, improving the dynamic flow range of the valve.

In any of the above embodiments, the edges 23d of the integrally formed seat and the angular face 20c of the butterfly valve plate 20 or the angular face 63d of the integrally formed seat and the edge 64a of the butterfly valve plate 64, the tolerance due to manufacturing yielding the seat and the butterfly valve plate may be coined out such that the entire outer circumference of the butterfly valve plate hits the seat at the same time. In a preferred embodiment, the materials of the integrally formed seat and the material of the butterfly valve plate have nearly the same coefficient of linear thermal expansion, such that no change is leakage performance is present over a temperature range.

Alternatively, as shown in FIG. 15, the butterfly valve plate may have an squared outer edge and the and the integrally formed seat in the inner diameter 23b of the cylindrical portion 23a of the valve housing 23 has an angled seat.

The mating of the edge seals on the outer circumference of the butterfly valve plate with the seat in the cylindrical housing, regardless of whether the angular edge is on the butterfly valve plate or the seat or the edge or corner is on the butterfly valve plate or the seat, results in an angular face to angular edge mating. Planar surface to surface contact between the butterfly valve plate and seat of the cylindrical portion of the valve housing does not occur.

The motor 10 may be a stepper motor or any other type of electric motor.

The ratio between the first bevel gear 40 and the second bevel gear 42 can vary and may be equal or different. Other gear set forms may also be used to accomplish the same function as shown in the Figures.

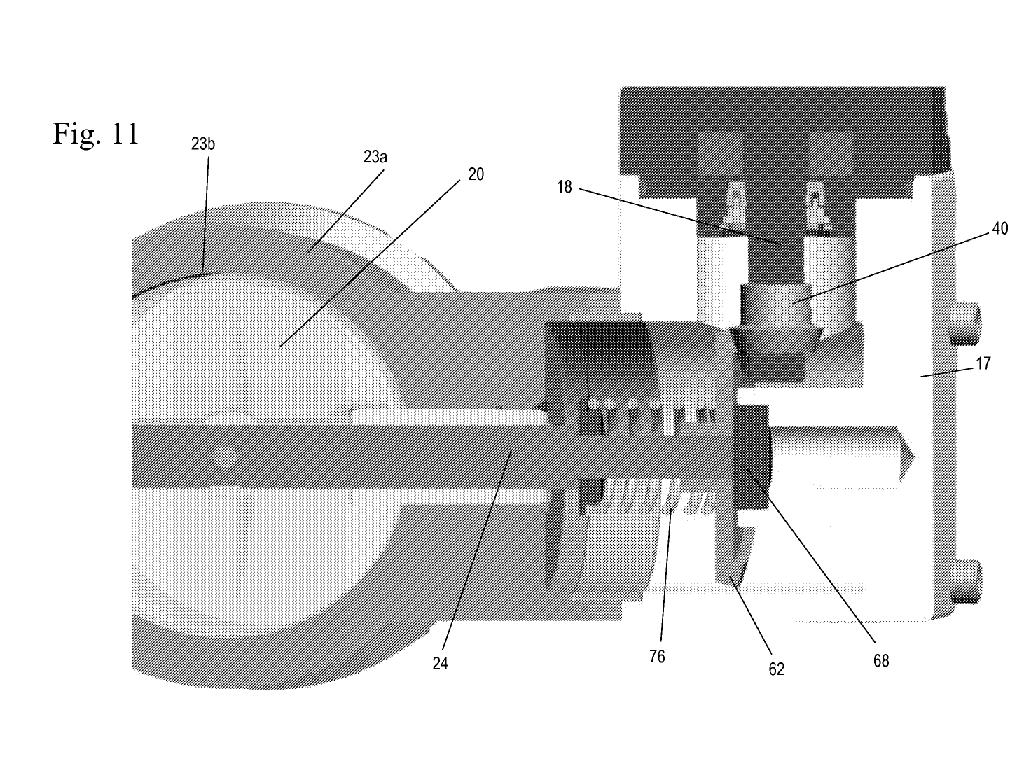

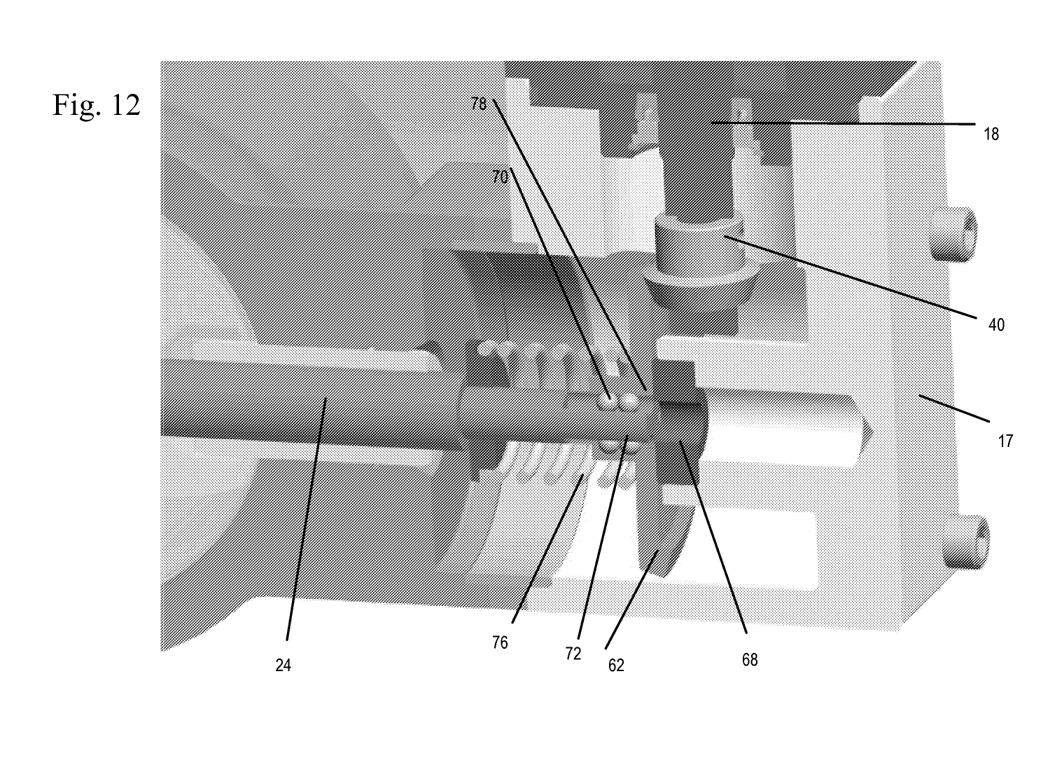

FIGS. 11-12 show a motor driven butterfly valve of a fourth embodiment. In this embodiment, the second bevel gear 62 attached to the butterfly shaft 24 has grooves 78 for receiving balls or pins 70 that key the second bevel gear 62 to corresponding mating grooves 72 on the butterfly shaft 24. The lock and key between the grooves 78 and the balls or pins 70 prevents the second bevel gear 62 rotating on the shaft 24 but allows the bevel gear 62 to slide along the axis of the butterfly shaft 24 via the spring load from a spring 76 present between the valve housing 23 or a retainer mounted on the butterfly shaft 24 as shown and the second bevel gear 62. The second bevel gear 62 will butt up against a face of the thrust bearing 68 at the proper aligned position to mate with the first bevel gear 40. It should be noted that the joint design of the bevel gear to the butterfly shaft 24 acts as a thermal break as well as the gear set 40, 42.

As shown in FIGS. 5, 13a, and 13b the butterfly valve plate 20 has a first side 20a and a second side 20b, the first side 20a being opposite from the second side 20b. The outer circumference of the butterfly valve plate 20 has angled end faces 20c that make line contact with an edge or corner 23d of the integrally formed angled seat 23c in the inner diameter 23b of the cylindrical portion 23a of the valve housing 23. When the butterfly shaft 24 is rotated, moving the butterfly valve plate 20 to a sealing position, the angled end face 20c formed on the outer circumference of the butterfly valve plate 20 on a first side 20a and a second side 20b seals at line contact with the corner or edge 23d of the integrally formed seat 23c in the inner diameter 23b of the cylindrical portion 23a of the valve housing 23. By having the seal formed between the edge 23d of integrally formed seat 23c and the angled face 20c on the outer circumference of the butterfly valve plate 20, soot does not coke up and internal leakage is low. Because of the edge sealing and the ability to brinell (coin) the mating surfaces of the angular face and the edge so that they conform exactly to one another, the seating stresses are high as compared with other designs. This enhances the low internal leakage sealing ability.

The angular face 20c or edge 64a on the outer circumference of the butterfly valve plate 20, 64 as shown in FIGS. 5, 13a, 13b, 14, and 15 when mating with the edge 23d or angular face 63d on the inner diameter 23b of the cylindrical portion 23a of the valve housing 23 also prevents the butterfly valve plate 20, 64 from wedging, ensuring that the butterfly valve plate 20, 64 hits the valve housing 23 at two positive stops. The angular face 20c or edge 64a on the outer circumference of the butterfly valve plate 20, 64 also reduces the required torque required by the motor 10 since the butterfly valve plate 20, 64 doesn't wedge with the cylindrical portion 23a of the valve housing 23. The edge 64a or angular face 20c on the outer circumference of the butterfly valve plate 64, 20 and the edge 23d or angular face 63d of the seat prevents soot build up since soot and debris cannot accumulate on the edges of the edge seal design. The design of the butterfly valve plate 20, 64 and the design of the seat provides low internal leakage when the butterfly valve plate 20, 64 is closed, giving superior low leakage performance, improving the dynamic flow range of the valve.

In any of the above embodiments, the edges 23d of the integrally formed seat and the angular face 20c of the butterfly valve plate 20 or the angular face 63d of the integrally formed seat and the edge 64a of the butterfly valve plate 64, the tolerance due to manufacturing yielding the seat and the butterfly valve plate may be coined out such that the entire outer circumference of the butterfly valve plate hits the seat at the same time. In a preferred embodiment, the materials of the integrally formed seat and the material of the butterfly valve plate have nearly the same coefficient of linear thermal expansion, such that no change is leakage performance is present over a temperature range.

Alternatively, as shown in FIG. 15, the butterfly valve plate may have an squared outer edge and the and the integrally formed seat in the inner diameter 23b of the cylindrical portion 23a of the valve housing 23 has an angled seat.

The mating of the edge seals on the outer circumference of the butterfly valve plate with the seat in the cylindrical housing, regardless of whether the angular edge is on the butterfly valve plate or the seat or the edge or corner is on the butterfly valve plate or the seat, results in an angular face to angular edge mating. Planar surface to surface contact between the butterfly valve plate and seat of the cylindrical portion of the valve housing does not occur.

The number of grooves, ball or pins is not limited to the number shown in the drawings.

The butterfly shaft 24 and the motor shaft 18 may be a common shaft.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A valve assembly comprising:
a motor shaft driven by and directly coupled to a motor;
a cam with a profile mounted to the motor shaft; and
a non-contact sensor proximate to the cam sensing a position of the motor shaft via the cam profile; and
a butterfly valve plate mounted on a butterfly shaft in a valve housing, the butterfly shaft being coupled to the motor shaft;
wherein a selected position of the butterfly valve plate may be set by activating the motor to a specific position determined by sensing the cam profile by the non-contact sensor.

2. The assembly of claim 1, further comprising a cooler between the motor and the valve housing.

3. The assembly of claim 2, further comprising a seal between the motor and the cooler.

4. The assembly of claim 1, wherein the motor shaft and the butterfly shaft are coupled by a flange.

5. The assembly of claim 1, wherein the motor shaft and the butterfly shaft are coupled by a hex pin.

6. The assembly of claim 1, wherein the motor shaft and the butterfly shaft are coupled by a pair of bevel gears.

7. The assembly of claim 1, wherein the profile of the cam is chosen such that the cam profile exterior sensed is less than 360 degrees.

8. The assembly of claim 1, further comprising a seal between the motor and the valve housing isolating exhaust gas and soot from entering the motor.

9. The assembly of claim 1, wherein the motor shaft and the butterfly shaft are a common shaft.

10. A valve comprising:
a butterfly valve plate comprising an angled outer circumference mounted on a butterfly shaft in a valve housing; and
a seat formed integrally within the valve housing comprising an edge for mating and sealing with the outer circumference of the butterfly valve plate;
wherein when the butterfly valve plate is rotated on the shaft to a sealing position, the sealing of the angled outer circumference of the butterfly valve plate and the integral seat occurs at line contact between the angled outer circumference of the butterfly valve plate and the edge of the integral seat in the valve housing.

11. A valve comprising:
a butterfly valve plate comprising an edge mounted on a butterfly valve shaft in a valve housing; and
a seat formed integrally within the valve housing comprising an angled face for mating and sealing with the outer circumference of the butterfly valve plate;
wherein when the butterfly valve plate is rotated on the shaft to a sealing position, the sealing of the edge on the outer circumference of the butterfly valve plate and the angled face of the integral seat occurs at line contact between the edge on the outer circumference of the butterfly valve plate and the angled face of the integral seat in the valve housing.
